(19) United States
(12) Patent Application Publication
(10) Pub. No.: US 2001/0045178 A1
(43) Pub. Date: Nov. 29, 2001

(54) Pigment dispersions

(76) Inventors: Masakazu Shirakawa, Osaka (JP); Koji Baba, Osaka (JP); Toshiya Inoue, Osaka (JP)

Correspondence Address: BIRCH STEWART KOLASCH & BIRCH, PO BOX 747, FALLS CHURCH, VA, 22040-0747, US

(21) Appl. No.: 09/833,561

(22) Filed: Apr. 13, 2001

(30) Foreign Application Priority Data
Apr. 14, 2000 (JP) 2000-113348
Jul. 13, 2000 (JP) 2000-212692

(51) Int. Cl. C08K 5/00

(52) U.S. Cl. 106/493; 106/499

(57) ABSTRACT

A pigment dispersion which comprises a pigment, a dispersant, a non-aqueous medium and a binder resin, wherein the amount of the binder resin is 10 to 60% by weight based on the amount of the pigment, and exhibits excellent dispersion stability in terms of viscosity, thixotropic property; and a photosensitive coloring composition comprising the pigment dispersion and used for manufacturing a colored pixel are provided.

### BACKGROUND OF THE INVENTION

The present invention relates to pigment dispersions. More particularly, the present invention relates to pigment dispersions used in the manufacture of color filters or the like to be incorporated in liquid crystal color display devices, image pickup devices or the like.

A color filter used in a liquid crystal color display device or an image pickup device is typically manufactured by forming pixels (picture cells) of three primary colors, namely, red, green and blue on a substrate such as a glass substrate, film substrate or silicon wafer. It is a common practice to provide a black matrix between one colored pixel and another for light shielding against each other. In forming each colored pixel, a process Is employed comprising the steps of: uniformly applying a photosensitive coloring composition containing a pigment corresponding to the color of each colored pixel on a substrate bearing a patterned light-shielding layer by means of a spin-coater or the like; heat-drying (pre-baking) the applied composition to form a dry coat; subjecting the dry coat to patterning exposure, followed by development; and heating (post-baking) the coat to post-curing. This series of operations is repeated for each color required in the color filter to obtain each colored pixel. In forming a black matrix, there may be used a photosensitive liquid containing a black pigment.

Such colored pixels are required to have higher transparency and, hence, the pigments used therein are required to have smaller particle diameter than commercially available typical ones. With finer pigment particles, however, the dispersion stability (shelf stability) lowers of a dispersion of such a pigment in a non-aqueous medium or of a photosensitive coloring composition prepared by adding a photopolymerization initiator, a photopolymerizable monomer and a binder resin to such a dispersion, Further, use of such a photosensitive coloring composition likely causes non-uniform application or generation of any foreign matter which results in problematic color filters having Insufficient brightness, poor contrast, unsatisfactory surface smoothness or the like.

In view of such circumstances, the inventors of the present invention have made an intensive study of pigment dispersions. As the result, they have found that, by blending a binder resin in a specified amount of 10 to 60% by weight relative to the amount of a pigment in a pigment dispersion, the shelf stability of the pigment dispersion as well as of a photosensitive coloring composition prepared using the pigment dispersion is improved. They have also found that the use of such a photosensitive coloring composition in a color filter can prevent non-uniform application thereof and generation of a foreign matter, thereby imparting the color filter with satisfactory brightness, contrast, surface smoothness, and the like. Thus, the present invention has been completed.

### SUMMARY OF THE INVENTION

The present invention provides a practically excellent pigment dispersion comprising a pigment, a dispersant, a non-aqueous medium, and a binder resin, wherein the amount of the binder resin is 10 to 60% by weight based on the amount of the pigment.

The present invention also provides a practically excellent photosensitive coloring composition comprising the pigment dispersion described above. The present invention further provides a practically excellent color filter manufactured by using the photosensitive coloring composition described above.

### MODE OF CARRYING OUT THE INVENTION

The pigment dispersion according to the present invention comprises a pigment, a dispersant, a non-aqueous medium and a binder resin.

The pigment may be any one of organic or inorganic pigments typically used in a pigment-dispersed resist. Examples of such inorganic pigments include metal compounds such as metal oxides and metal complexes. Specifically, they include oxides and compound oxides of metals such as iron, cobalt, nickel, aluminum, cadmium, lead, copper, titanium, magnesium, chromium, zinc, and antimony, Examples of such organic pigments include those compounds classified as Pigments In “Color Index” (published by The Society of Dyers and Colourists). these pigments may be used either alone or in combination of two or more of them.

More specifically, compounds of the following color indexes (C.I.) can be mentioned as organic pigments used in the present invention, although organic pigments used in the present invention are not limited to them.

C.I. Pigment Yellow 20, 24, 31, 53, 83, 86, 93, 94, 109, 110, 117, 125, 137, 138, 139, 147, 148, 150, 152, 153, 154, 155, 166, 173, 180, and 185:

C.I. Pigment Orange 13, 31, 36, 38, 40, 42, 43, 51, 55, 59, 61, 64, 65, 71, and 73;

C.I. Pigment Red 9, 97, 105, 122, 123, 144, 149, 166, 168, 176, 177, 180, 192, 215, 216, 224, 242, 254, 255, 264, 270. and 272;

C.I. Pigment Violet 14, 19, 23, 29, 32, 33, 36, 37, and 38;

C.I. Pigment Blue 15 (such as C.I. Pigment Blue 15:3, 15:4, and 15:6), 21, 22, 28. 60, and 64;

C.I. Pigment Green 7, 10, 15, 25, 36, and 47

C.I. Pigment Brown 28;

C.I. Pigment Black 1, 1 and the like.

Among them, diketopyrrolopyrrol pigments such as C.I. Pigment orange 71 and 73 and C.I. Pigment Red 254, 255, 264, 270, and 272 are preferred.

The dispersant many be any one selected from various known dispersants. Examples of specific dispersants used in the present invention include polyester-type polymeric dispersants, acrylic-type polymeric dispersants, polyurethane-type polymeric dispersants, pigment derivatives, cationic surface active agents, anionic surface active agents, and nonionic surface active agents. Particularly. polymeric dispersants having an amine value and/or an acid value are preferable. These dispersants may be used either alone or in combination of two or more of them.

The dispersant is used usually in an amount of about 1 to 100% by weight, preferably about 5 to 50% by weight based on the amount of the pigment.

The non-aqueous medium may be any one of various non-aqueous media used in the art of photoresists. Examples of specific non-aqueous media include esters such as methyl acetate, ethyl acetate, propyl acetate, isopropyl acetate, butyl acetate, isobutyl acetate, methyl propionate, ethyl propionate, propyl propionate, butyl propionate, ethyl pyruvate, methyl 3-methoxypropionate and ethyl 3-ethoxypropionate; ketones such as acetone, methyl ethyl ketone, methyl amyl ketone, diisobutyl ketone, cyclopentanone, and cyclohexane; glycol ether esters such as 3-methoxybutyl acetate and propylene glycol monomethyl ether acetate: and aromatic hydrocarbons such as benzene, toluene, and o-, m- or p-xylene. These non-aqueous media may be used either alone or as a mixture of two or more of them.

The non-aqueous medium is used usually in an amount of about 25 to 900% by weight, preferably about 65 to 400% by weight based on the amount of the pigment.

The binder resin acts to allow an unexposed coat to be developed by alkali while serving as a dispersion medium of the pigment. The present invention uses a copolymer having a polymerization unit derived from (meth)acrylic acid. The term “(meth)acrylic acid” used in the instant specification means acrylic acid or methacrylic acid, and similarly the term “(meth)acrylate” means acrylate or methacrylate. This copolymer is usually obtained by copolymerization of (meth)acrylic acid and any other monomer copolymerizable therewith. Hence, the copolymer contains a carboxyl group originating from the (meth)acrylic acid.

The monomer that is copolymerizable with (meth)acrylic acid is a compound having a polymerizable carbon-carbon unsaturated bond. Examples of such compounds include aromatic vinyl compounds such as styrene, α-methylstyrene, and vinyltoluene; unsaturated carboxylic acid alkyl esters such as methyl (meth)acrylate, ethyl (meth)acrylate, butyl (meth)acrylate, 2-hydroxyethyl (meth)acrylate, and benzyl (meth)acrylate; unsaturated carboxylic acid aminoalkyl esters such as aminoethyl acrylate; unsaturated carboxylic acid glycidyl esters such as glycidyl (meth)acrylate; carboxylic vinyl esters such as vinyl acetate and vinyl proprionate; vinyl cyanide compounds such as (meth)acrylontrile and α-chloroacrylonitrile; and unsaturated carboxylic acids other than (meth)acrylic acid such as crotonic acid, itaconic acid, maleic acid, and fumaric acid. These monomers may be used either alone or in combination of two or more of them for copolymerization with (meth)acrylic acid.

Examples of suitable copolymers having a polymerization unit derived from (meth)acrylic acid include (meth)acrylic acid/benzyl (methacrylate copolymer, (meth)acrylic acid/benzyl (meth)acrylate/styrene copolymer, (meth)acrylic acid/methyl methacrylate copolymer, and (meth)acrylic acid/methyl methacrylate/styrene copolymer. Each of these copolymers having a polymerization unit derived from (meth)acrylic acid may be modified at its side chain by a compound having a photosensitive group. Such modified copolymers are also included in the meaning of the term “copolymer having a polymerization unit derived from (meth)acrylic acid” used in the present invention.

Such a binder resin preferably has a weight-average molecular weight of 5,000 to 400,000, more preferably 1,000 to 300,000 in terms of polystyrene-converted weight measured by gel-permeation chromatography. The acid value of such a binder resin is preferably within the range of about 10 to about 200 mgKOH/g.

In the pigment dispersion of the present invention, the amount of the binder resin is 10 to 60% by weight, preferably 20 to 40% by weight based on the amount of the pigment. If the amount of the binder resin is less than 10% by weight, the shelf stability of the resulting pigment dispersion tends to lower. If the amount of the binder resin is more than 60% by weight, the color strength of the resulting pigment dispersion tends to weaken. Thus, either case is not preferable.

The pigment dispersion according to the present invention is prepared using the foregoing pigment, dispersant, non-aqueous medium and binder resin. In the preparation, it is possible to add the pigment to a mixture comprising the dispersant, non-aqueous medium and binder resin and make the pigment to disperse in the mixture. However, a preferable preparation process comprises the following steps: adding the pigment to a mixture of the non-aqueous medium and the dispersant; mixing the resulting mixture by means of DISPER, high-speed stirrer, paint shaker or the like to obtain a pre-dispersion; then dispersing the pigment until the average particle diameter of the pigment becomes about 0.2 μm or less by means of a dispersing machine such as a roll mill, ballmill, sandmill, beadmill, or high-speed stirring mill; and thereafter adding the binder resin to form the pigment dispersion. In the dispersing process, the content of solid components (ratio of the total weight of pigment and Ads dispersant to the total weight of pigment, dispersant and non-aqueous medium) is preferably within the range of 10 to 80% by weight. The binder resin is preferably added after dissolved in the non-aqueous medium. The acid value of the pigment dispersion is preferably 10 mgKOH/g or more.

In the case where two or more pigments are used in combination, particularly where a pyrrolopyrrole pigment is used in combination with any other pigment, it is preferable that each pigment is dispersed in a mixture of the dispersant and the non-aqueous medium, then the dispersion is mixed with the binder resin, and thereafter the resulting mixtures are mixed with each other.

A photosensitive coloring composition of the present invention can be prepared by adding a binder resin, a photopolymerizable monomer and a photopolymerization initiator, and optionally other additives as required to the pigment dispersion thus prepared, followed by mixing the resulting mixture. In this case, a stirring device commonly used can be used as a mixer.

Examples of binder resins used in the preparation of the photosensitive coloring composition include the binder resins same as those mentioned above. The binder resin used in this process may be same as or different from the binder resin used in preparation of the pigment dispersion as explained above. The total amount of binder resins used in the photosensitive coloring composition is usually about 50 to about 200% by weight, preferably 60 to 130% by weight based on the amount of the pigment contained in the photosensitive coloring composition.

The photopolymerizable monomer is a compound that is polymerizable by actions of light and the photopolymerization initiator- An example of such a compound is a compound having a polymerizable carbon-carbon unsaturated bond. The photopolymerizable monomer may be a monofunctional monomer, a bifunctional monomer, or other polyfunctional monomer. Examples of specific monofunctional monomers include nonylphenyl carbitol acrylate, 2-hydroxy-3-phenoxypropyl acrylate, 2-ethylhexyl carbitol acrylate, 2-hydroxyethyl acrylate, and N-vinylpyrrolidone Examples of specific bifunctional monomers include 1,6-hexanediol di(meth)acrylate, ethylene glycol di(meth)acrylate, neopentyl glycol di(meth)acrylate, triethylene glycol di(meth)acrylate, bis(acryloyloxyethyl) ether of bisphenol A, 3-methylpentanediol di(meth)acrylate, and tricyclodecanedimethanol di(meth)acrylate. Examples of other polyfunctional monomers include trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and tris(methacryloyloxyethyl) isocyanurate.

Particularly preferable among such photopolymerizable monomers are those having an acrylic group (CH₂═CHCO—) and a larger number of such acrylic groups per unit weight of the compound, namely, those having a smaller acrylic group equivalent weight represented by the weight in gram of the compound per one equivalent of acrylic group. Among others, a compound having an acrylic group equivalent weight of 100 or less is preferably used. As the acrylic group equivalent weight increases, the sensitivity of a resulting dried coat is likely to become poorer in the exposure and development processes. Such poor sensitivity may lower the productivity of color filters. Since a compound having a smaller acrylic group equivalent weight is preferable, a bifunctional monomer or a higher polyfunctional mononer is naturally preferable. Example of such monomers having an acrylic group equivalent weight of 100 or less include ethylene glycol diacrylate, trimethylolpropane triacrylate, pentaerythritol triacrylate, pentaerythritol tetraacrylate, and dipentaerythritol hexaacrylate. Particularly preferable among them are trimethylolpropane triacrylate. pentaerythritol tetraacrylate, and dipentaerythritol hexaacrylate.

Such photopolymerizable monomers may be used alone or in combination of two or more of them. The photopolymerizable monomer is added usually in an amount of 5 to 90% by weight, preferably 20 to 70% by weight based on the total weight of all the solid contents in the photosensitive coloring agent (the weight obtained by subtracting the weight of the non-aqueous medium from the weight of the photosensitive coloring composition).

Any photopolymerization initiator used in this technical field may be used as a component of the photosensitive coloring composition of the present invention. Examples of such photopolymerization initiators include acetophenone-type initiators, benzoin-type initiators, benzophenone-type initiators, thioxanthone-type initiators, and other initiators. Examples of specific acetophenone-type initiators include oligomers such as diethoxyacetophenone, 2-hydroxy-2-methyl-1-phenylpropane-1-one, benzyldimethylketal, 2-hydroxy-1-[4-(2-hydroxyethoxy)phenyl]-2-methylpropane-1-one, 1-hydroxycyclohexyl phenyl ketone, 2-methyl-1-(4-methylthiophenyl)-2-morpholinopropane-1-one, 2-benzyl-2-dimethylamino-1-(4-morpholinophenyl)butane-1-one, 2-hydroxy-2-methyl-1-[4-(1-methylvinyl)phenyl]propane-1-one. Examples of specific benzoin-type initiators include benzoin, benzoin methyl ether, benzoin ethyl ether, benzoin isopropyl ether, and benzoin isobutyl ether. Examples of specific benzophenone-type initiators include benzophenone, methyl o-benzoyl benzoate, 4-phenylbenzophenone, 4-benzoyl-4′-methyldiphenyl sulfide, 3,3′,4,4′-tetra(tert-butyl peroxycarbonyl)benzophenone, and 2,4,6-trimethylbenzophenone. Examples of specific thioxanthone-type initiators include 2-isopropyl thioxanthone, 4-isopropyl thioxanthone, 2,4-diethyl thioxanthone, 2,4-dichlorothioxanthone, and 1-chloro-4-propoxy thioxanthone. Examples of other initiators include 2,4,6-trimethylbenzoyl diphenylphosphine oxide, 2,2′-bis(o-chlorophenyl)-4,4′, 5,5′-tetraphenyl-1,2′-bii midazole, 10-butyl-2-chloroacridone, 2-ethylanthraquinone, benzyl. 9,10-phenanthrenequinone, camphorquinone, methyl phenylglyoxylate, and titanocene compounds. These photopolymerization initiators may be used either alone or in combination of two or more of them.

The photopolymerization initiator may be used, optionally, in combination with a photopolymerization initiation assistant. Such a photopolymerization initiation assistant may be, for example, an amine-type or alkoxyanthracene-type. Examples of such initiation assistants include triethanolamine, methyldiethanolamine, triisopropanolamine, methyl 4-dimethylamino benzoate, ethyl 4-dimethylamino benzoate, isoamyl 4-dimethylamino benzoate, 2-ethylhexyl 4-dimethylamino benzoate, 2-dimethylaminoethylbenzoate, N,N-dimethyl paratoluidine, 4,4′-bis(dimethylamino)benzophenone (common name: Michler's ketone), 4,4′-bis(diethylamino)benzophenone, 9,10-dimethoxyanthracene, 2-ethyl-9,10-dimethoxyanthracene, 9,10-diethoxyanthracene, and 2-ethyl-9,10-diethoxyanthracene. These photopolymerization initiation assistants maybe used either alone or in combination of two or more of them.

The total amounts of the photopolymerization initiator and optionally-used photopolymerization initiation assistant contained in the photosensitive coloring composition is usually 3 to 50 parts by weight, preferably 5 to 40 parts by weight per on 100 parts by weight of the binder resin and the photopolymerizable mononer in total.

As required, the photosensitive coloring composition may contain other additives such as filler, other polymeric compound, adherence accelerator, antioxidant, UV absorber, and agglomeration inhibitor Examples of such fillers include glass, silica and alumina. Examples of other polymeric compounds include polyvinyl alcohol, polyacrylic acid, polyethylene glycol monoalkyl ether and polyfluoroalkyl acrylate. Examples of specific adherence accelerators include vinyltrimethoxysilane, vinyltriethoxysilane, vinyl-tris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane. 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloyloxypropyltrimethoxysilane and 3-mercaptopropyltrimethoxysilane. Examples of specific. antioxidants include 2,2′-thiobis(4-methyl-6-tert-butylphenol) and 2,6-di-tert-butyl-4-methylphenol. Examples of specific UV absorbers include 2-(3-tert-butyl-2-hydroxy-5-methylphenyl)-5-chlorobenzo triazole and alkoxybenzophenone. Examples of specific agglomeration inhibitors include sodium polyacrylate.

A coat formed by applying the photosensitive coloring composition thus prepared onto a substrate and subsequent drying is subjected to patterning exposure, alkali development and then thermosetting, to give a colored pixel of excellent display quality such as color reproducibility and reliability. A color filter having such a colored pixel is incorporated into a liquid crystal color display or the like to form a liquid crystal panel. In the patterning exposure is typically employed a process such as to irradiate the coat with ultraviolet ray through a mask for forming a desired pixel. In this process, use of a mask aligner or the like is preferable for allowing the whole exposed portion of the coat to be uniformly irradiated with parallel rays.

The developer used in the development following the patterning exposure is typically an aqueous solution containing an alkaline compound and a surface active agent. Such an alkaline compound may be either an inorganic alkaline compound or an organic alkaline compound, Examples of such inorganic alkaline compounds include sodium hydroxide, potassium hydroxide, disodium hydrogen phosphate, sodium dihydrogen phosphate, diammonium hydrogen phaphate, ammonium dihydrogen phosphate, potassium dihydrogen phosphate, sodium silicate, potassium silicate, sodium carbonate, potassium carbonate, sodium bicarbonate, potassium bicarbonate, sodium borate, potassium borate and ammonia. Examples of organic alkaline compounds include tetramethylammonium hydroxide, 2-hydroxyethyltrimethylammonium hydroxide, monomethylamine, dimethylamine, trimethylamine, monoethylamine, diethylamine, triethylamine, monoisopropylamine, diisopropylamine and ethanolamine. These inorganic and organic alkaline compounds may be used either alone or as a mixture of two or more of them, The concentration of the alkaline compound in the alkali developer is preferably 0.01 to 10% by weight, more preferably 0.03 to 5% by weight.

The surface active agent may be any one of a nonionic surface active agent, a cationic surface active agent and an anionic surface active agent. Examples of specific nonionic surface active agents include polyoxyethylene alkyl ether, polyoxyethylene aryl ether, polyoxyethylene alkylaryl ether, other polyoxyethylene derivatives, oxyethylene/oxypropylene block copolymer, sorbitan fatty acid ester, polyoxyethylene sorbitan fatty acid ester, polyoxyethylene sorbitol fatty acid ester, glycerin fatty acid ester, polyoxyethylene fatty acid ester and polyoxyethylene alkylamine. Examples of specific anionic surface active agents include higher alcohol sulfuric ester salts such as sodium lauryl alcohol sulfuric ester and sodium oleyl alcohol sulfuric ester; alkyl sulfates such as sodium lauryl sulfate and ammonium lauryl sulfate; alkylaryl sulfonates such as sodium dodecylbenzene sulfonate and sodium dodecylnaphthalene sulfonate. Examples of specific cationic surface active agents include amine salts or quaternary ammonium salts such as stearylamine hydrochloride and lauryl trimethylammonium chloride. These surface active agents may be used either alone or in combination of two or more of them. The concentration of the surface active agent in the alkali developer is usually 0.01 to 10% by weight, preferably 0.05 to 8% by weight, more preferably 0.1 to 5% by weight.

Through the operations described above, namely, application of the photosensitive coloring composition onto a substrate, drying, patterning exposure of the dried coat and development, a colored pixel having the color of the pigment in the photosensitive coloring agent is obtained. By repeating a series of these operations for every color required, a color filter is obtained. More specifically saying, a typical color filter comprising a red-colored pixel, a blue-colored pixel and a green-colored pixel on a substrate can be obtained by the following steps 1)-3).

1) A series of the aforementioned operations is performed using the photosensitive coloring composition containing a pigment corresponding to a certain color to obtain a colored pixel in that color.

2) Likewise, the same operation series is performed using the photosensitive coloring composition containing a pigment corresponding to another color, thereby obtaining a colored pixel in that color.

3) In this way, colored pixels of respective three primary colors can be formed on a substrate.

According to the present invention, the binder resin is contained in a specified amount of 10 to 60% by weight in the pigment dispersion thereby improving the shelf stability of the pigment dispersion as well as of the photosensitive coloring composition prepared by using the pigment dispersion. Further, use of the photosensitive coloring composition can prevent non-uniform application thereof onto a substrate and generation of any foreign matter. Hence, a colored pixel that is excellent in contrast, brightness and surface smoothness can be provided. Putting it in another way, the pigment dispersion as well as the photosensitive coloring composition prepared using the same can be handled easily. By using the photosensitive coloring composition of the present invention, a color filter excellent in transparency, surface roughness and contrast can be easily manufactured. When such a color filter is incorporated into a liquid crystal color display device, a liquid crystal panel of excellent display quality such as color reproducibility and reliability is obtained.

Hereinafter, the present invention will be described more specifically by way of examples, which should not be construed to limit the scope of the present invention. The “%” and “part(s)” used to represent the content of any component or the amount of any material used in the following examples are on a weight basis unless otherwise specifically noted.

### EXAMPLE 1

### Preparation of a Pigment Dispersion

C.I. Pigment Red 254 in an amount of 3.95 parts, a dispersant; SOLSPERSE32000 (produced by AVECIA CO., LTD.) in an amount of 1.19 parts, and propylene glycol monomethyl ether acetate in an amount of 7.7 parts were premixed together using DISPER at 500 rpm for one hour, To the resulting premix was added 50 parts of zirconia beads, and the mixture was stirred with a high-speed stirring mill for five hours to cause the pigment to disperse. To the resulting mixture was then added a mixed solution of 1.19 parts of a binder resin (benzyl methacrylate/methacrylic acid copolymer: composition by weight ratio=80/20, weight-average molecular weight=350,000, and acid value=99.1 mgKOH/g) and 17.58 parts of propylene glycol monomethyl ether acetate, followed by further stirring for 30 minutes. Then, the zirconia beads were removed from the mixture to give a pigment dispersion (A1).

### EXAMPLE 2

### Preparation of a Pigment Dispersion

C.I. Pigment Red 254 in an amount of 3.95 parts, the same dispersant as used in Example 1 in an amount of 1.19 parts propylene glycol monomethyl ether acetate in an amount of 25.28 parts, and the same binder resin as used in Example 1 in an amount of 1.19 part were premixed together using DISPER at 500 rpm for one hour. To the resulting premix was added 50 parts of zirconia beads, and the mixture was stirred with a high-speed stirring mill for five hours to cause the pigment to disperse. Then, the zirconia beads were removed from the mixture to give a pigment dispersion (A2).

### EXAMPLE 3

### Preparation of a Pigment Dispersion

C.I. Pigment Yellow 139 in an amount of 1.05 parts, the same dispersant as used in Example 1 in an amount of 0.32 parts, and propylene glycol monomethyl ether acetate in an amount of 2.06 parts were premixed together using DISPFR at 500 rpm for one hour, To the resulting premix was added 13 parts of zirconia beads, and the mixture was stirred with a high-speed stirring mill for five hours to cause the pigment to disperse. To the resulting mixture was then added a mixed solution of 0.32 parts of the same binder resin as used in Example 1 and 4.71 parts of propylene glycol monomethyl ether acetate, followed by further stirring for 30 minutes. Then, the zirconia beads were removed from the mixture to give a pigment dispersion (B).

### EXAMPLE 4

### Preparation of a Pigment Dispersion

The pigment dispersions (A1) and (B) obtained in Examples 1 and 3, respectively, were mixed together at a weight ratio of 81:19 to give a pigment dispersion (Cl).

### EXAMPLE 5

### Preparation of a Pigment Dispersion

The pigment dispersions (A2) and (B) obtained in Examples 2 and 3, respectively, were mixed together at a weight ratio of 81:19 to give a pigment dispersion (C2).

### EXAMPLE 6

### Preparation of a Pigment Dispersion

C.I. Pigment Red 254 in an amount of 2.90 parts, C.I. Pigment Yellow 139 in an amount of 1.05 parts, the same dispersant as used in Example 1 in an amount of 1.51 parts, and propylene glycol monomethyl ether acetate in an amount of 9.76 parts were premixed together using DISPER at 500 rpm for one hour. To the resulting premix was added 63 parts of zirconia beads, and the mixture was stirred with a high-speed stirring mill for five hours to cause the pigment to disperse. To the resulting mixture was then added a mixed solution of 1.51 parts of the same binder resin as used in Example 1 and 22.29 parts of propylene glycol monomethyl ether acetate, followed by further stirring for 30 minutes. Then, the zirconia beads were removed from the mixture to give a pigment dispersion (C3).

### Comparative Example 1

### Preparation of a Pigment Dispersion

A pigment dispersion (AX) was prepared according to the same conditions as in Example 1 except that 17.98 parts of propylene glycol monomethyl ether acetate was added instead of the mixed solution of 1.19 parts of the binder resin and 17.58 parts of propylene glycol monomethyl ether acetate used in Example 1.

### Comparative Example 2

### Preparation of a Pigment Dispersion

A pigment dispersion (BX) was prepared according to the same conditions as in Example 2 except that 4.77 parts of propylene glycol monomethyl ether acetate was added instead of the mixed solution of the binder resin and propylene glycol monomethyl ether acetate used in Example 2.

### Comparative Example 3

### Preparation of a Pigment Dispersion

The pigment dispersions (AX) and (BX) obtained in Comparative Examples 1 and 2, respectively, were mixed together at a weight ratio of 81:19 to give a pigment dispersion (CX).

Evaluation 1 (Shelf Stability of Pigment Dispersions)

Change with time in the viscosity of each dispersion was measured at 23° C. The viscosity was measured using an R-type viscometer with its rotor revolving at 20 rpm. The thixotropic property of each dispersion was represented by X/Y, where X is a viscosity measured by the R-type viscometer with its rotor revolving at 5 rpm and Y is a viscosity measured by the R-type viscometer with its rotor revolving at 20 rpm. The results of the measurement are shown in Tables 1 and

2. The parenthesized values are values obtained after lapse of one month.

TABLE 1
Shelf stability of pigment dispersion

| Pigment dispersion | (A1) | (A2) | (AX) |
|---|---|---|---|
| Viscosity | 10.68 | 7.98 | Unmeasurable* |
| (mPa · s) | (11.15) | (8.34) | |
| Thixotropic property | 0.98 | 1.20 | Unmeasurable* |
| | (1.03) | (0.97) | |

Remark:
*Measurement was impossible due to thickening after dispersion.

### EXAMPLES 7-9

### Preparations of Photosensitive Coloring Compositions

Each of the pigment dispersions obtained in Examples 4 to 6 in an amount of 100 parts was mixed with 10.55 parts of the same binder resin as used in Example 1, 14.33 parts of dipentaerythritol hexaacrylate, 3.48 parts of 2-Methyl-1-(4-methylthiophenyl)-2-morpholinopropan-1-one (Irgacure907 produced by CHIBA-GEIGY Co.) as a photopolymerization initiator, 1.73 parts of 2,4-Diethylthioxanthone (KAYACURE DETX-S produced by NIPPON KAYAKU Co., LTD) and 120 parts of propylene glycol monomethyl ether acetate, to give photosensitive red-coloring compositions (D1), (D2) and (D3).

### Comparative Example 4

### Preparation of a Photosensitive Coloring Composition

The pigment dispersion obtained in Comparative Example 3 in an amount of 100 parts was mixed with 17.6 parts of the same binder resin as used in Example 1, 17.6 parts of dipentaerythritol hexaacrylate, 4.28 parts of 2-Methyl-1-(4-methylthiophenyl)-2-morpholinopropan-1-on e(Irgacure907 produced by CHIBA-GEIGY CO.) as a photopolymerizatlon initiator, 2.12 parts of 2 2, 4-Diethylthioxanthone (KAYACURE DETX-S produced by NIPPON KAYAKU CO., LTD) and 166.2 parts of propylene glycol monomethyl ether acetate, to give photosensitive red-coloring composition (DX).

Evaluation 2 (Shelf Stability of Photosensitive Coloring Compositions)

Change with time in the viscosity of each photosensitive coloring composition was measured at 23° C. The viscosity and the thixotropic property of each dispersion were measured according to the same ways as in Evaluation 1. The results of the measurement are shown in Table 3. The parenthesized values are values obtained after lapse of one month.

TABLE 2
Shelf stability of photosensitive coloring composition

| Photosensitive | | | | |
|---|---|---|---|---|
| coloring | | | | |
| composition | (D1) | (D2) | (D3) | (D4) |
| Viscosity | 6.87 | 5.58 | 6.24 | 12.09 |
| (mPa · s) | (6.87) | (6.33) | (7.36) | (10.92) |
| Thixotropic | 1.07 | 1.02 | 1.11 | 1.29 |
| property | (1.03) | (1.18) | (1.29) | (1.21) |

Evaluation 3 (Performance of Coat)

A glass substrate (coning #7059) was coated with each of the photosensitive coloring compositions prepared in the above Examples and Comparative Example using a spin-coater, and the resulting coat was dried by pre-baking at 100° C. for three minutes. The coat thus dried was subjected to exposure at 150 mj/cm² using an ultra high-pressure mercury light and then post-baked at 230° C. for 20 minutes, to give red coats. The film thickness of each red coat after the post-baking was measured using a stylus-type film thickness gauge. The substrate thus formed with each red coat was interposes between a pair of polarizers to measure a luminance obtained when the polarization axes of the two polarizers were parallel to each other (parallel luminance) and a luminance obtained when the polarization axes of the two polarizers were perpendicular to each other (perpendicular luminance). The ratio of the parallel luminance to the perpendicular luminance (luminance ratio a parallel luminance/perpendicular luminance) was determined as contrast. The results of evaluation of film thickness, contrast and surface condition rare shown in Table3. Surface conditions were rated by visual observation into the following categories: ◯ representing a uniform surface condition; Δ representing a surface condition with few white spots observed: and X representing a surface condition with white spots clearly observed.

TABLE 3
Performance of coat formed from photosensitive coloring
composition

| Photosensitive | | | | |
|---|---|---|---|---|
| coloring composition | (D1) | (D2) | (D3) | (DX) |
| Film thickness of coat | 1.16 | 1.22 | 1.19 | 1.20 |
| Contrast | 717.7 | 625.5 | 619.8 | 464.9 |
| Surface condition | ◯ | ◯ | Δ | X |

The pigment dispersion according to the present invention exhibits excellent dispersion stability in terms of viscosity, thixotropic property and the like. The photosensitive coloring composition prepared using the pigment dispersion also exhibits excellent dispersion stability in terms of viscosity, thixotropic property and the like. Using the photosensitive coloring composition of the present invention, a colored pixel excellent in transparency, surface smoothness and contrast can be easily obtained. A liquid crystal color display panel of superior display quality such as color reproducibility and reliability can be manufactured by incorporating a color filter having such colored pixels into the panel.

What is claimed is:

1. A pigment dispersion comprising a pigment, a dispersant, a non-aqueous medium, and a binder resin, wherein the amount of the binder resin is 10 to 60% by weight based on the amount of the pigment.

2. The pigment dispersion according to claim 1, wherein the amount of the binder resin is 20 to 40% by weight based on the amount of the pigment.

3. The pigment dispersion according to claim 1, wherein the binder resin has a weight-average molecular weight of 5,000 to 400,000 in terms of polystyrene-converted weight measured by gel-permeation chromatography.

4. The pigment dispersion according to claim 1, wherein amount of the dispersant is 1 to 100% by weight, and amount of the non-aqueous medium is 25 to 900% by weight based on the amount of the pigment.

5. The pigment dispersion according to claim 1, which is obtained by adding the pigment to a mixture of the non-aqueous medium and the dispersant; then dispersing the pigment; and thereafter adding the binder resin to form the pigment dispersion.

6. The pigment dispersion according to claim 1, which comprises two or more kinds of pigments and is obtained by adding and dispersing each pigment in a mixture of the non-aqueous medium and the dispersant; then adding the binder resin to form a mixture of each pigment; and there after mixing the resulting mixtures with each other.

7. The pigment dispersion according to claim 1 which comprises a pyrrolopyrrole pigment.

8. The pigment dispersion according to claim 6 which comprises a pyrrolopyrrole pigment.

9. The pigment dispersion according to claim 1 wherein the content of solid components is within the range of 10 to 80% by weight.

10. The pigment dispersion according to claim 1 wherein acid value of the pigment dispersion is 10 mgKOH/g or more.

11. A photosensitive coloring composition comprising the pigment dispersion according to claim 1.

12. A color filter which is manufactured by using the photosensitive coloring composition according to claim 8.
